(19) United States
(12) Patent Application Publication
(10) Pub. No.: US 2006/0045647 A1
(43) Pub. Date: Mar. 2, 2006

(54) Shock absorbing transport frame

(76) Inventors: Nick Verbrugge, Kanawha, IA (US); Charles Spitler, West Des Moines, IA (US)

Correspondence Address: Davis, Brown, Koehn, Shors & Roberts, P.C.;The Financial Center, Suite 2500, 666 Walnut Street, Des Moines, IA, 50309-3993, US

(21) Appl. No.: 10/929,205

(22) Filed: Aug. 30, 2004

(51) Int. Cl. B64C 1/22

(52) U.S. Cl. 410/77

(57) ABSTRACT

A shock absorbing transport frame is provided. The frame comprises an inner frame and an outer frame capable of supporting a transportation device. The outer frame is secured to the inner frame in a manner that will control movement between the inner and outer frames. The frame includes a pneumatic system that controls movement between the inner and outer frames. The pneumatic system has a pressurized air source and at least one air bag located to buffer movement between the inner and outer frames. A proximity switch monitors the position of the inner and outer frames and communicates changes to a logic controller that adjusts the flow of air in the air bag to maintain a neutral position.

### BACKGROUND OF THE INVENTION

The present invention comprises a shock absorbing transport frame. In particular, a shock absorbing transport frame having an inner and outer frame connected in a manner that will dampen movement between the inner and outer frame through the utilization of a four bar linkage.

The use of transportation vehicles like ambulances for emergency transportation of injured patients to health care facilities comprises a necessary and standard practice across the world. The ability to quickly respond to medical emergencies save many lives, however, the transportation of patients to hospitals involves a certain amount of risk due to the translation of vertical and horizontal movement of the transportation vehicle to the patient usually supine on a gurney or stretcher inside the vehicle.

The resulting jostling of an injured patient can result in more than discomfort. In the cases of certain injuries that require complete immobilization, the sudden and irregular movement resulting from vehicle transportation can result in substantial additional impairment to the patient. Furthermore, the emergency vehicle often must travel at high speeds in order to quickly transport the patient to a medical facility for treatment, especially in the case of grave emergencies. The faster the vehicle travels the greater the intensity of vibration experienced by the patient.

Thus, a need exists for a transportation frame the better dampens oscillation and vibration from a transportation vehicle.

### SUMMARY OF THE INVENTION

An object of the present invention comprises providing a shock absorbing transport frame.

An object of the present invention comprises providing a shock absorbing transport frame that includes a pneumatic system.

These and other objects of the present invention will become apparent to those skilled in the art upon reference to the following specification, drawings, and claims.

The present invention intends to overcome the difficulties encountered heretofore. To that end, a shock absorbing transport frame is provided. The frame comprises an inner frame and an outer frame capable of supporting a transportation device. The outer frame is secured to the inner frame in a manner that will control movement between the inner and outer frames. A pneumatic system controls the movement between the inner and outer frames.

### BRIEF DESCRIPTION OF THE DRAWINGS

FIG. 1 is a side view of an inner and outer frame of a shock absorbing transport frame.

FIG. 2 is an end view of the inner and outer frame of FIG. 1 along the line 2-2 shown in FIG. 1.

FIG. 3 is a top view of the shock absorbing transport frame with the outer frame attached to the inner frame.

FIG. 4 is a perspective view of the inner and outer frame of the shock absorbing transport frame.

FIG. 5 is a perspective view of the shock absorbing transport frame with the outer frame attached to the inner frame.

FIG. 6 is a schematic drawing of a pneumatic system of an alternative shock absorbing transport frame.

FIG. 7 is schematic drawing of an electrical system of the alternative shock absorbing transport frame.

FIG. 8 is a side view of the alternative shock absorbing transport frame.

FIG. 9 is a perspective view of a logic controller of the alternative shock absorbing transport frame.

FIG. 10 is a perspective view of solenoids of the alternative shock absorbing transport frame.

FIG. 11 is a perspective view of air bags and of a proximity switch of the alternative shock absorbing transport frame.

FIG. 12 is a perspective view of the air bags of the alternative shock absorbing transport frame.

FIG. 13 is a perspective view of the proximity switch and the airbags of the alternative shock absorbing transport frame.

FIG. 14 is a perspective view of a pressure switch of the alternative shock absorbing transport frame.

FIGS. 15-17 are perspective views of a buffer tank of the alternative shock absorbing transport frame.

### DETAILED DESCRIPTION OF THE INVENTION

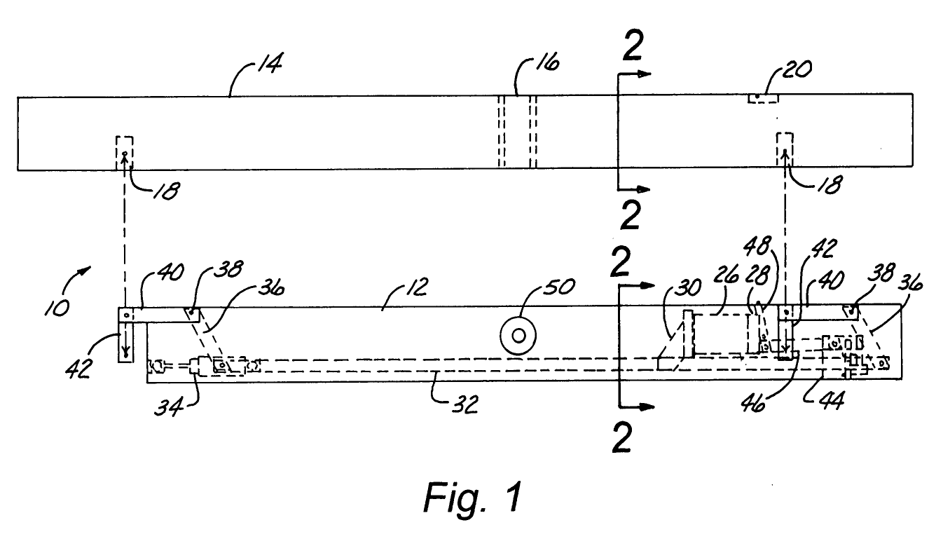

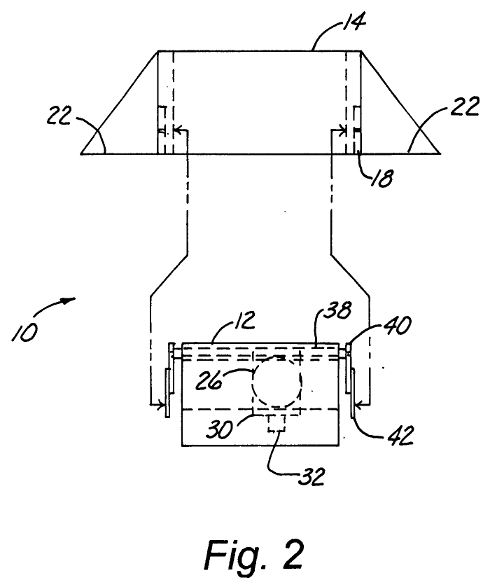

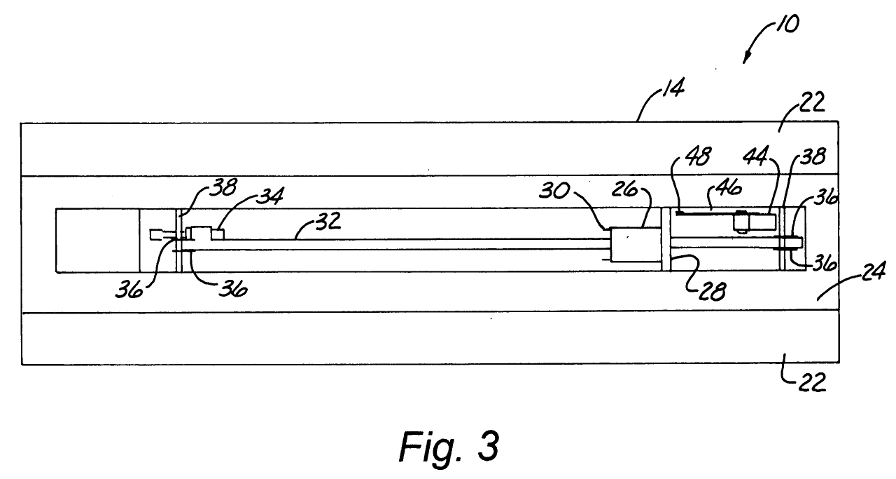

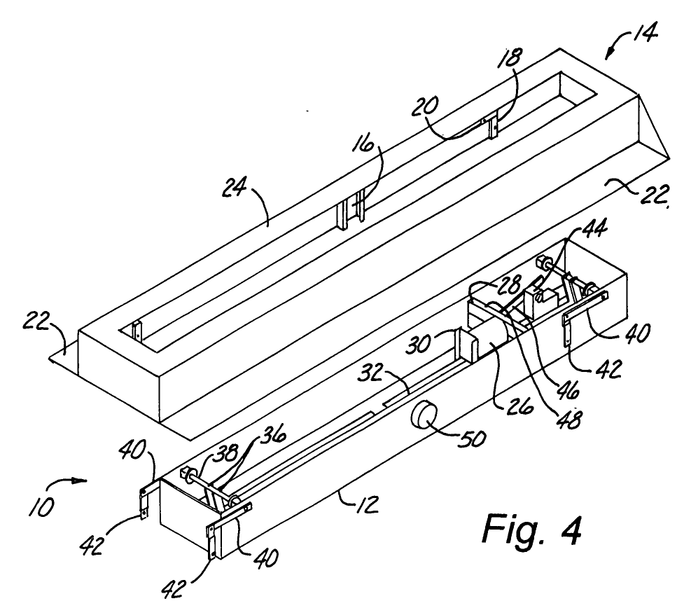

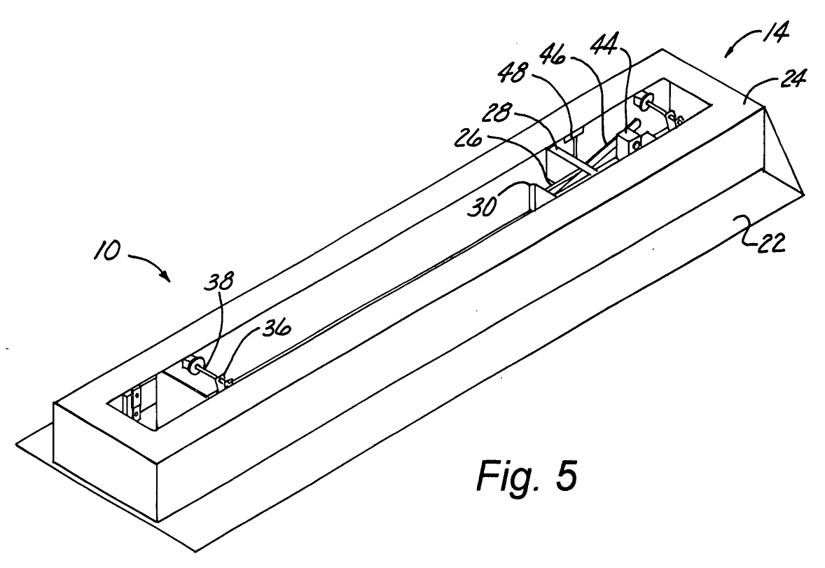

In the figures, FIG. 1 shows a shock-absorbing transport frame 10. The transport frame 10 includes an inner frame 12 and an outer frame 14. In the preferred embodiment of the invention, the inner frame 12 is attachable to the floor of a transportation vehicle (not shown) like an ambulance. The outer frame 14 includes a generally rectangular shaped raised center box section 24 with flange skirts 22 extended from a lower portion of the center box 24 along its longitudinal axis (see FIGS. 3-4). Additionally, the outer frame 14 is shaped such that it adapts to support a gurney or stretcher type device when such a device is positioned in the transport vehicle. In the preferred embodiment of the invention, the transport vehicle is an ambulance.

The outer frame 14 of the transport frame 10 includes several connection points for attachment to the inner frame 12; these include link arm connectors 18, air valve link arm connector 20, and collar bracket 18. The outer frame 14 fits over the inner frame 12 such that guide bearings 50 attached to either side of the inner frame 12 secure within the collar brackets 16. The link arm connectors 18 secure to the second connector arms 42 of the inner frame 12 with bolts. In this manner, the inner frame 12 is nested inside the outer frame 14.

The inner frame 12 includes a pneumatically activated air bag 26 rigidly mounted to the inner frame 12 with air bag mount 28. Opposite to air bag mount 28, the air bag 26 is secured to an air bag link arm 30 that links the air bag 26 to an elongated shaft 32. The opposite ends of the elongated shaft 32 are connected to shaft bracket arms 36. The shaft bracket arms 36 are mounted to support posts 38 that secure to the inside of the inner frame 12. First connector arms 40 are secured to the outer ends of the support post 38, and second connector arms 42 extend generally downward from the end of the first connector arms 40 opposite to the end connected to the support post 38. Connected to one end of the elongated shaft 32 is a shock absorber 34.

The inner frame 12 also includes a pneumatically activated air valve 44 connected to a first air valve link arm 46 that is in turn connected to a second air valve link arm 48. The second air valve link arm 48 secures to the air valve link arm connector 18 on the outer frame 14.

In operation, the outer frame 14 moves in relation to the inner frame 12 wherein that movement is cushioned or dampened by the combined effect of the shock absorber 34 and the air bag 26. The air valve 44 provides for a self-adjusting mechanism to maintain a constant gap between the inner and outer frame 12, 14 despite variations in the force applied either by vibration or by oscillation of the transport vehicle or variations in the weight of a patient being transported therein. In particular, variable vertical force exerted upon the outer frame 14 is translated into movement of the first connector arms 40, second connector arms 42, and shaft bracket arms 36. These components maintain a rigid orientation with relationship to each other, but pivot through rotation of support posts 36. Moving in this manner, the vertical force applied to the outer frame 14 causes movement of the elongated shaft 32 that is dampened by the shock absorber 34.

Thus, the elongated shaft 32, the outer frame 14, and the linkage connecting the two, form a four bar linkage that moves together in response to variable pressures exerted on the inner and outer frames 12, 14. The variable force can result from movement of the underlying transportation vehicle, or from changes in the weight of a patient being transported.

The air bag 26 and air valve 44 are in operable communication with a 12-volt air compressor (note shown) that provides a self-adjusting mechanism to adjust the position of the outer frame 14 relative to the inner frame 12 to maintain a constant distance between the frames 12, 14. An airline (not shown) pneumatically connects the air valve 44 to the air compressor, and second air line (not shown) pneumatically connects the air valve 44 to the air bag 26. In this manner, the system acts to return the frames 12, 14 to a neutral position relative to each other. In particular, variations in load will cause vertical movement of the outer frame 14 that will move the first air valve link arm 46 and the second air valve link arm 48. This movement will trigger the air valve 44 to adjust the air pressure in the air bag 26 coming from the air compressor. This adjustment of air pressure in the air bag 26 will act to return the inner and outer frames 12, 14 back to the neutral position.

Moreover, downward vertical movement of the outer frame 14 will move the four bar linkage such that the elongated shaft 32 moves to right as seen in FIG. 1, this will compress the air bag 26 and move the first air valve link arm 46 and the second air valve link arm 48 downward thereby triggering the air valve to increase the air pressure to the air bag 26. The air pressure increases until movement of the four bar linkage and first air valve link arm 46 and the second air valve link arm 48 reverses, thereby returning the inner and outer frames 12, 14 to a neutral position. Of course, upward vertical movement of the outer frame 14 will result in a similar compensation effect, with the movements and adjustments reversed. The shock absorber 34 will continue to exert a dampening effect during the self-adjusting process, as well as acting generally to dampen vibration and oscillation coming from the transportation vehicle.

The second air valve link arm 48 includes a two piece threaded shaft that adjusts. Turning the pieces of the arm 48 in one direction will lengthen the arm 48, and turning it in the other direction will shorten the arm. The neutral position between the inner and outer frames 12, 14 is adjusted in this manner.

In this manner, the shock absorbing transport frame 10 provides for self-compensating shock absorption in response to movement of a gurney or stretcher-type device placed upon the outer frame 14, when the frame 10 is affixed inside a transport vehicle like an ambulance. Thus, in the ambulance application, sudden and erratic movement common to moving vehicles along with variation in patient weight is compensated for in a manner that protects the patient and provided for a more comfortable, cushioned, and safer ride during transportation.

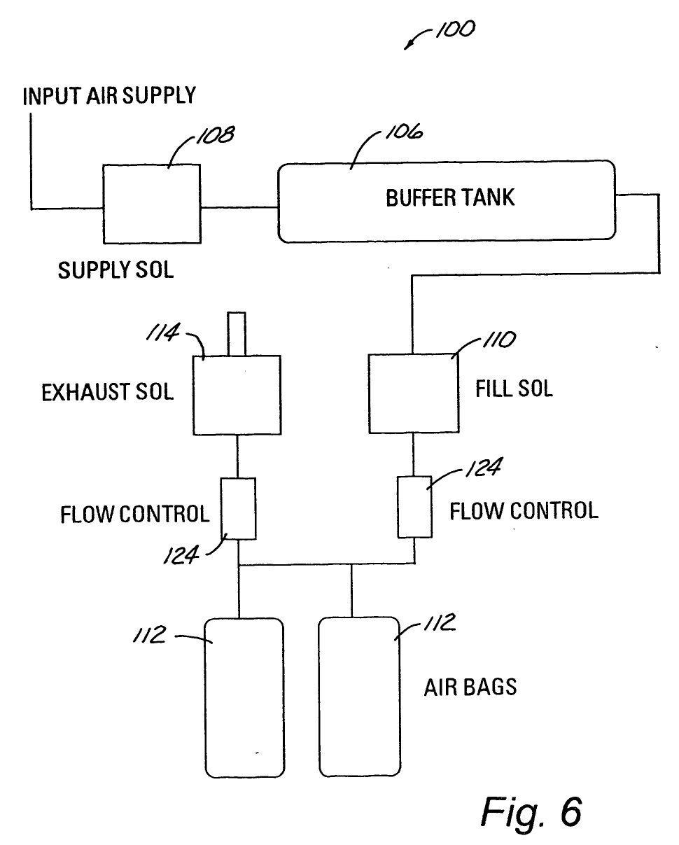

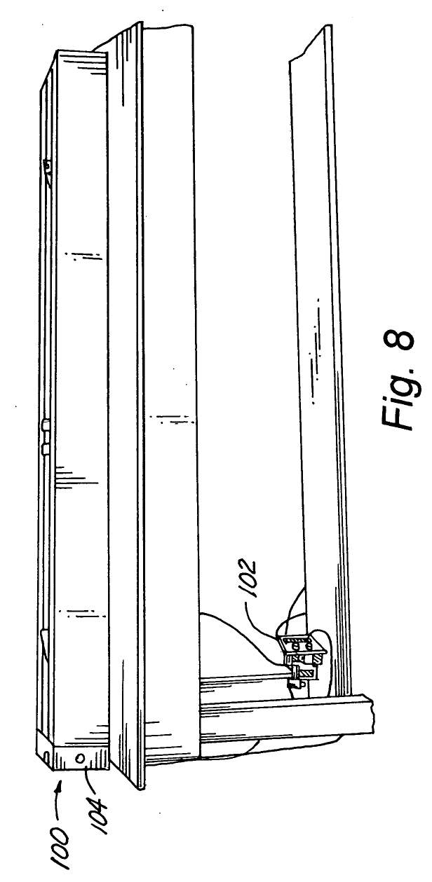

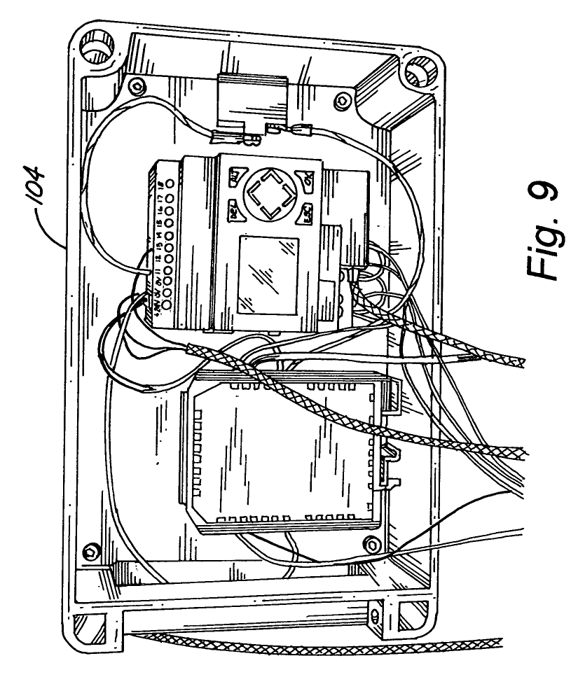

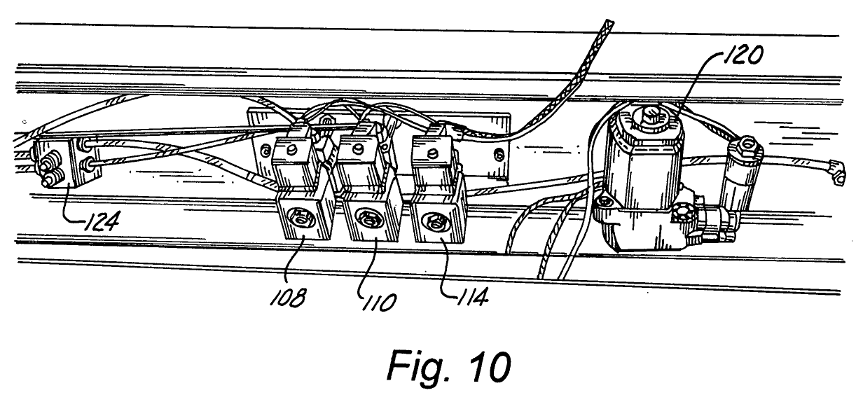

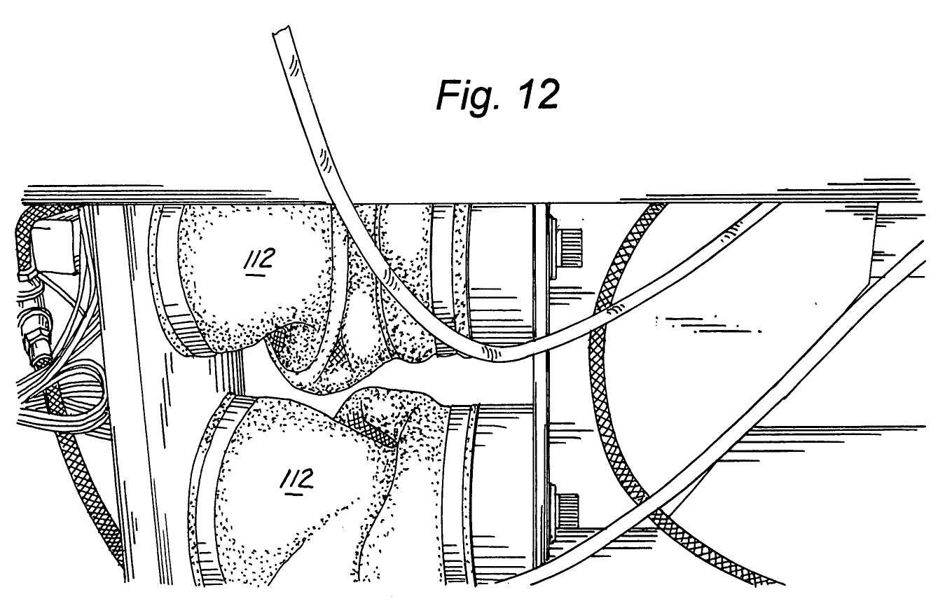

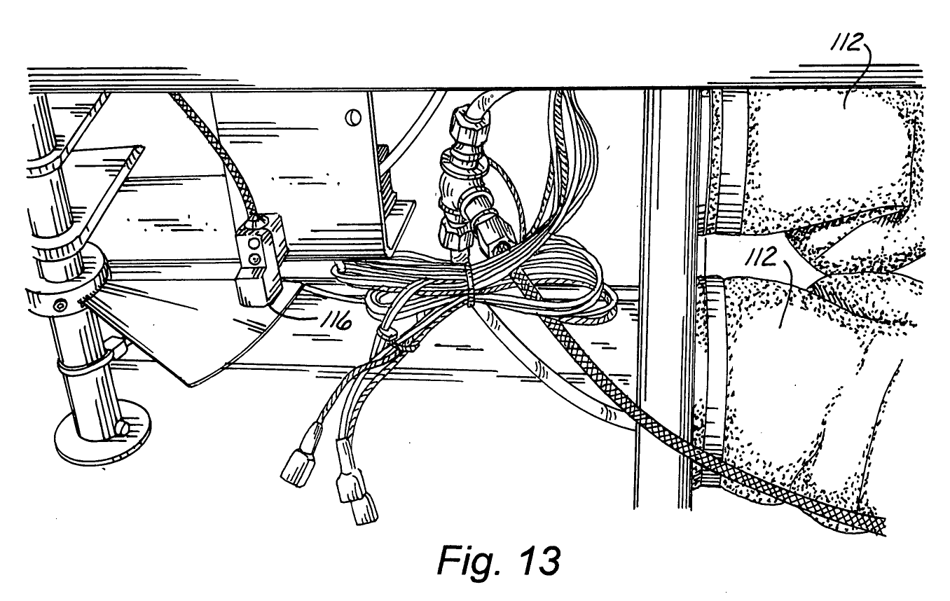

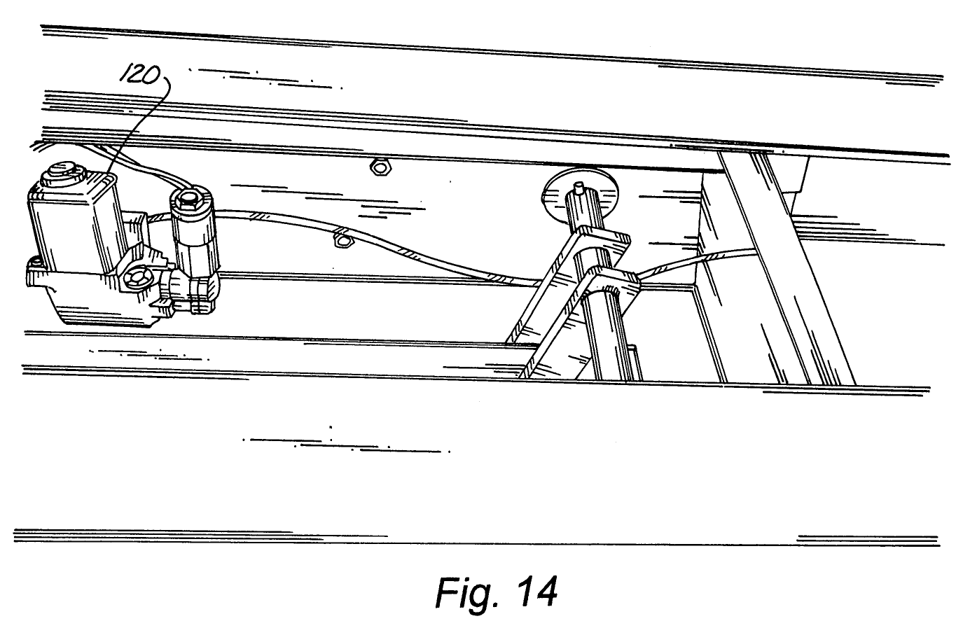

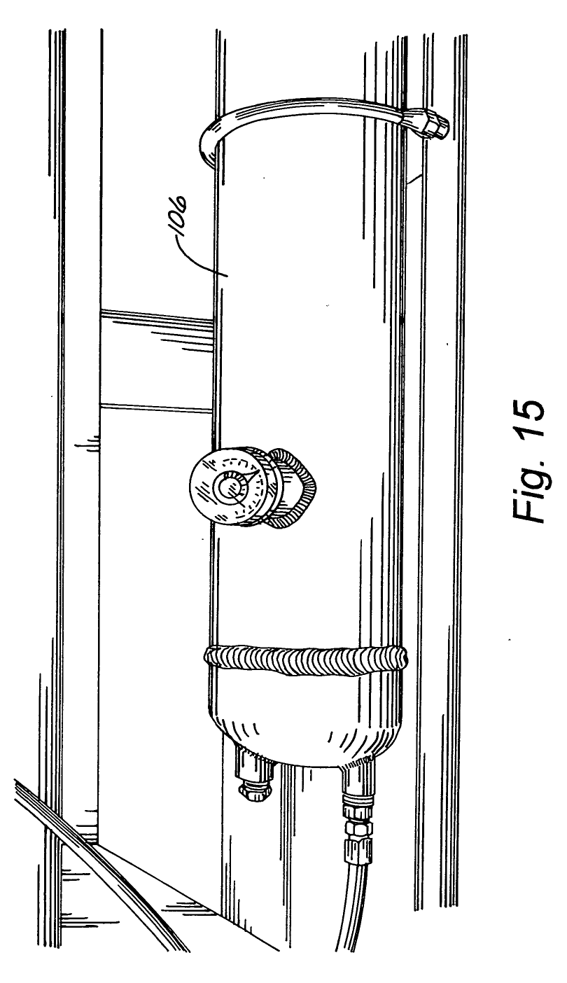

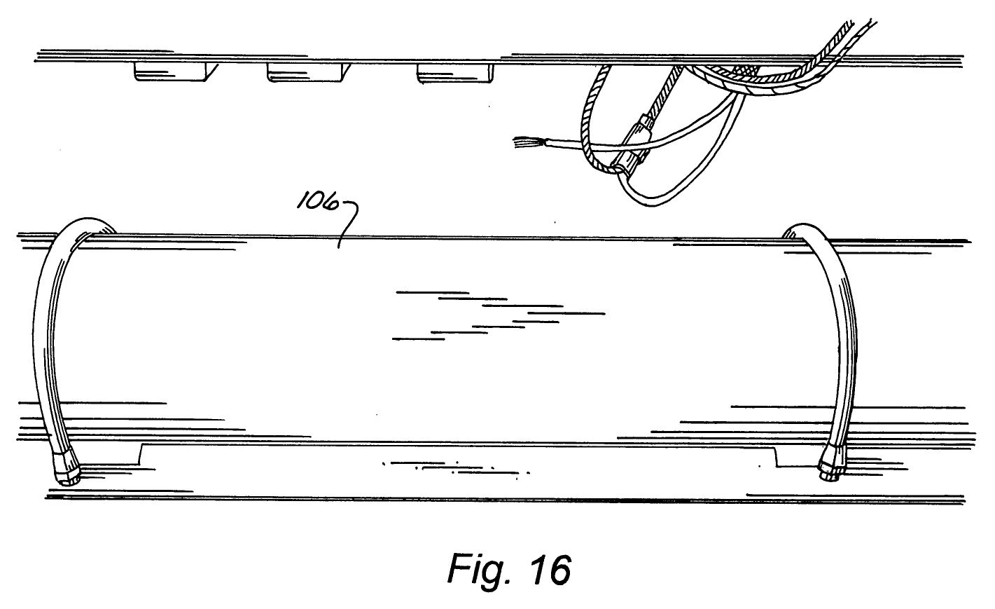

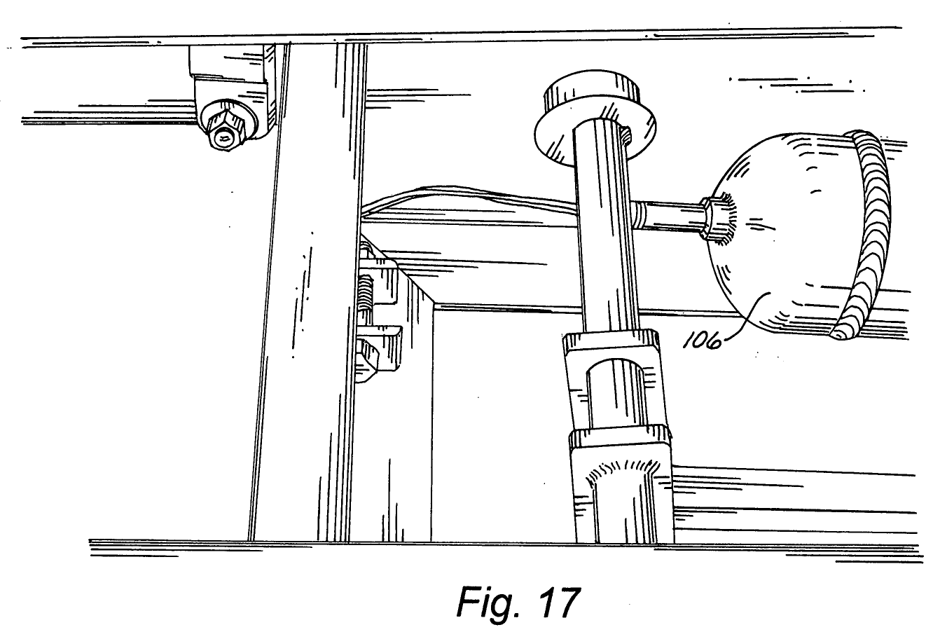

In an alternative embodiment as seen in FIGS. 6-17, the movement between the inner frame 12 and the outer frame 14 is controlled by a pneumatic system 100. This pneumatic system 100 provides a self-adjusting mechanism that adjusts the position of the outer frame 14 relative to the inner frame 12 to maintain a constant distance between the frames 12, 14 in response to varying load forces.

In this embodiment, the pneumatic system 100 includes a buffer air tank 106 to supply pressurized air to the system 100. The air tank 106 can be mounted to the inner frame 12 as shown in the Figures, or remotely located in the transport vehicle. Alternatively, an air compressor could be used to provide a constant source of pressurized air to the system 100. A supply solenoid 108 opens and closes airflow to the air tank 106. Airflow to air bags 112 is opened and closed by a fill solenoid 110. An exhaust solenoid 114 opens and closes airflow from the air bags 112. Flow control regulators 124 are located between the air bags 112 and the fill and exhaust solenoids 110, 114 for fine control of the rate of flow to and from the air bags 112.

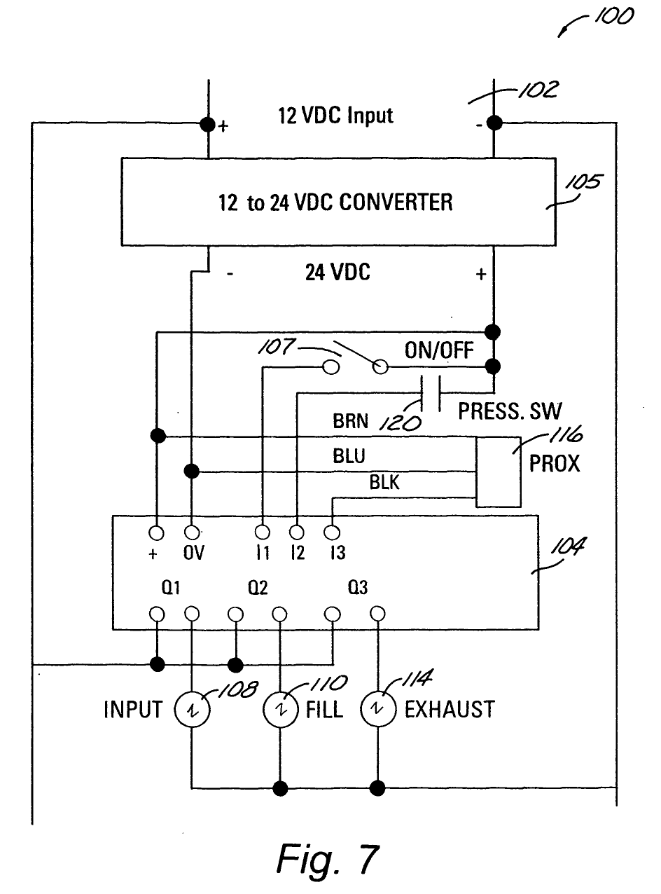

The system 100 is under the electrical control of a logic controller 104. A power supply 102 powers the logic controller 104. Typically, the logic controller 104 is connected to a 12V power supply with a 12 to 24V converter 105. However, the system 100 can use a 24V controller thereby eliminating the converter 105. As best seen in FIGS. 7-10, the logic controller 104 activates the supply, fill, and exhaust solenoids 108, 110, 114 that open and close air supply to the various components of the system 100.

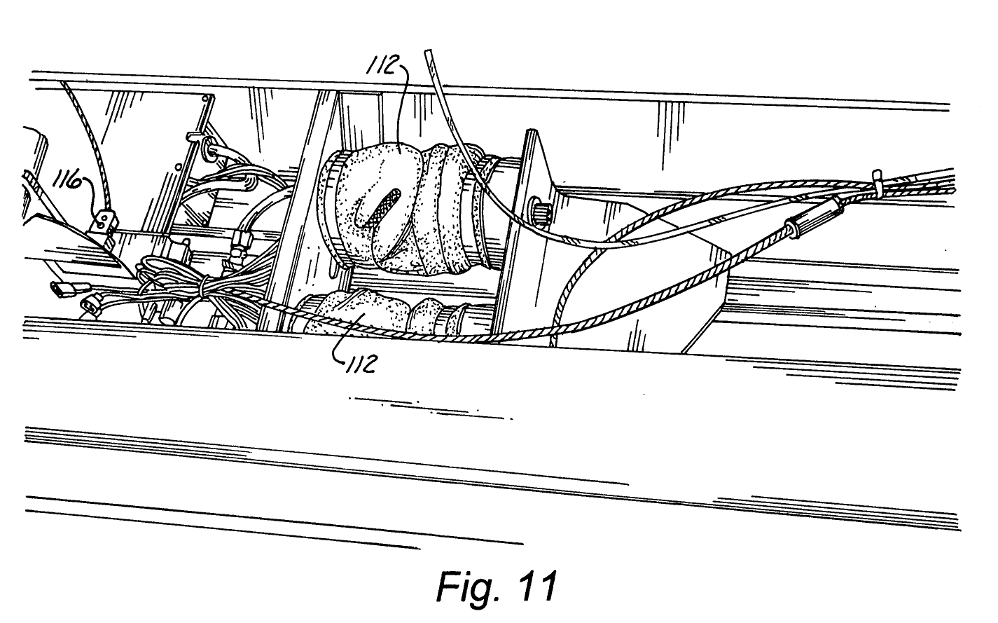

The pneumatic system 100 also includes a proximity switch 116 that senses changes in the ride/height position, as seen in FIGS. 11-13. The proximity switch 116, in conjunction with the controller 104, creates a feedback loop to keep the shock absorbing transport frame at a neutral height. When the proximity switch 116 senses a change in the height from the neutral position, the feedback loop notifies the logic controller 104 to activate the appropriate solenoids 108, 110, 114 to open and close in a manner that returns the inner and outer frames 12, 14 to a neutral height.

The pneumatic system has a pressure switch 120 to pressurize the system and monitor the level of air pressure in the buffer tank 106. For example, if the buffer tank 106 should be maintained at preferably a constant pressure of 90 psi and the pressure drops below this level, the pressure switch 120 activates an input air supply to fill the air tank 106. The input air supply can be for example, an air compressor or any other similar type device. The pressure switch 120 is connected to the logic controller 104.

In addition, the solenoids 108, 110, 114 have flow controls 124 to finely adjust the flow of air out of the solenoids.

The pneumatic system includes an on/off switch 107 to activate the system 100. The switch is also important in the event of an emergency that requires deactivation of the system 100. For example, the on/off switch 107 could be used if a patient on the gurney required chest compressions or resuscitation that the cushioning effect might interfere with.

It is contemplated that the system would also include a tilt switch to deactivate the system 100 in case of an emergency with the transport vehicle such as a roll over.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

1. A shock absorbing transport frame, said frame comprising:
an inner frame;
an outer frame capable of supporting a transportation device, and secured to said inner frame in a manner that will control movement between said inner and outer frames;
wherein said movement control is provided by a four bar linkage operating between said inner and outer frame; and
a pneumatic system in operable communication with said inner frame to control movement between said inner and outer frames.

2. The invention in accordance with claim 1 wherein said pneumatic system further comprises a source of pressurized air and at least one air bag located to buffer movement between said inner and outer frames.

3. The invention in accordance with claim 2 wherein said pneumatic system further comprises an input solenoid for controlling air into said source of pressurized air.

4. The invention in accordance with claim 2 wherein said pneumatic system further comprises an output solenoid for controlling air out of said source of pressurized air and into said air bag.

5. The invention in accordance with claim 2 wherein said pneumatic system further comprises an exhaust solenoid for venting compressed air from said air bag.

6. The invention in accordance with claim 2 wherein said pneumatic system further comprises a proximity switch to monitor movement between said inner frame and said outer frame.

7. The invention in accordance with claim 2 wherein said pneumatic system further comprises a pressure switch to pressurize the system.

8. The invention in accordance with claim 2 wherein said pneumatic system further comprises a power supply in operable communication with a logic controller that controls flow of air through the pneumatic system.

9. The invention in accordance with claim 3 further comprising a flow regulator to adjust airflow out of said input solenoid.

10. The invention in accordance with claim 4 further comprising a flow regulator to adjust airflow out of said output solenoid.

11. The invention in accordance with claim 5 further comprising a flow regulator to adjust airflow out of said exhaust solenoid.
